(19) United States
(12) Patent Application Publication
(10) Pub. No.: US 2002/0112286 A1
(43) Pub. Date: Aug. 22, 2002

(54) Patient movement aid

(76) Inventors: Helen Upton, Swansea (GB); Michael Simmons, Carmarthen (GB)

Correspondence Address: E. Schindler, Five Hirsch Ave., P.O. Box 966, Coram, NY, 11727-0966, US

(21) Appl. No.: 09/790,138

(22) Filed: Feb. 21, 2001

(51) Int. Cl. A61G 7/10

(52) U.S. Cl. 5/81.1 HS; 5/81.1 R

(57) ABSTRACT

The aid for movement of a patient comprises a unitary tubular member of blown plastics sheeting having first and second open ends, and a unitary seamless flexible web extending substantially continuously and uniformly from the first end to the second end, the tubular member being arranged to lie flat under the weight of the patient such that opposed portions of an inner face of the web are in sliding contact with one another.

### BACKGROUND OF THE INVENTION

The invention is concerned with a patient movement aid for use in, for example, hospitals, nursing homes, disability centers or the like, and a method of using the same.

### PRIOR ART

It is common practice to use a patient movement aid or a patient transfer sheet to enable patients to be moved (for example by sliding or rolling) over a support surface (such as a surface of a bed or gurney) or from one support surface to another (such as from a chair to a wheelchair). Such movement aids or sheets are usually of textile or fabric material and include seams, stitches, joins or the like. The presence of such seams or stitches may cause discomfort and pain to a patient while the patient is moved on such a movement aid or transfer sheet.

### OBJECT OF THE INVENTION

It is an object of the invention to provide an improved and cost-effective patient movement aid, which at least alleviates the disadvantages of the known patient movement aids.

### SUMMARY OF THE INVENTION

The invention provides a patient movement aid for moving a patient from a first position on a support surface to a second position on the support surface, the movement aid comprising a flexible sheet comprising a unitary tubular member of blown plastics sheeting having first and second open ends, and a unitary seamless flexible web extending substantially continuously and uniformly from the first end to the second end, the tubular member being arranged to lie flat under the weight of the patient such that opposed portions of an inner face of the web are in sliding contact with one another.

The present invention also provides a method of moving a patient from a first position on a support surface to a second position on the support surface, the method comprising:

providing a patient movement aid, as described above;

placing the patient movement aid on the support surface such that the movement aid lies substantially flat on the support surface;

placing a patient on the patient movement aid; and

moving the patient over the support surface, on the patient movement aid, in such a manner that the opposed portions of the inner face of the web slide relative to one another.

### DETAILED DESCRIPTION OF THE INVENTION

It is preferred that the flexible web should be seamless in a longitudinally extending direction of the web. It is further preferred that the web should be seamless in a transverse direction. More preferably, the flexible web is seamless both in the longitudinally extending direction and also in a transverse direction. Advantageously, the seamless nature of the flexible sheet constituting the patient movement aid may help to minimize pain and discomfort to a patient when the latter is moved from one position to another on the support surface.

It is desirable that the inner face of the flexible web should have a low coefficient of friction to enable facile sliding movement of opposed portions of the inner face.

In one embodiment, the outer surface of the web may have a higher coefficient of friction relative to the inner face thereof, so as to substantially inhibit sliding movement between the outer surface of the web and the support surface. In other words, the flexible sheet may be moved across a support surface (such as the surface of a bed or gurney) substantially by sliding contact of opposed portions of the inner face of the web (rather than by sliding movement of the outer surface of the web relative to the support surface of the bed or gurney).

The outer surface of the tubular member may be such that is has a higher frictional coefficient relative to the inner face of the web. Preferably, the inner face and the outer surface of the web may be provided with means for distinguishing the inner face from the outer surface. For instance, they be color-coded (each having a different distinctive color) or, alternately, the outer surface may have a graphical representation, logo, indicium or wording printed thereon.

Advantageously, the movement aid according to the invention may be substantially crease-resistant and may furthermore be foldable to allow storage.

In addition, the movement aid may be such that it can be readily cleaned, for example, by sponging or wiping down with alcohol or the like.

For this purpose, and for hygienic and other reasons, it is preferred that the patient movement aid is substantially impervious to water, alcohol and the like.

The flexible sheet typically has a transverse dimension of about 65 centimeters and a longitudinal dimension of about 90 centimeters.

The movement aid according to the invention may be used to move a patient to a sitting position, or to roll a patient over onto a side or the like. In use, the movement aid may be placed on a support surface of, for example, a bed, a gurney, a patient examination table, a chair, or wheelchair or the like and substantially adjacent to the patient. The patient may be carefully placed, slid or rolled on to the movement aid, and the inner face of the sheet may then be slidably moved (either by the patient or by a helper) to enable the patient to transfer from a first position to a second position. The movement aid may then be removed from under the patient.

### BRIEF DESCRIPTION OF THE DRAWINGS

FIG. 1 is a schematic representation of the patient movement aid according to the invention.

FIGS. 2, 3 and 4 are schematic representations of the patient movement aid according to the present invention, in use.

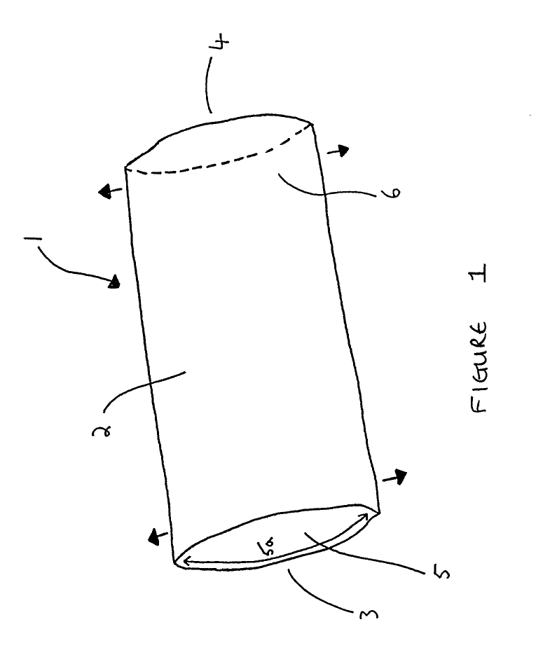

FIG. 1 shows a patient movement aid generally designated by reference numeral 1. The movement aid 1 comprises a flexible plastics sheet in the form of a unitary tubular member 2. The tubular member 2 has longitudinally spaced open ends 3,4 and a longitudinally extending flexible web 6 extending from one open end 3 to the other open end 4, longitudinally spaced therefrom. The flexible plastics sheeting of the tubular member 2 is seamless in a longitudinally extending direction and also in a transversely extending direction of the flexible web 6.

The web 6 has an inner face 5 and an outer surface. The inner face 5 has a sufficiently low coefficient of friction to allow opposed portions of the inner face 5 to slide relative to one another. A portion 5a may slide relative to an overlying portion of the inner face 5 to move the tubular member 2 (and the patient thereon) from one position to another.

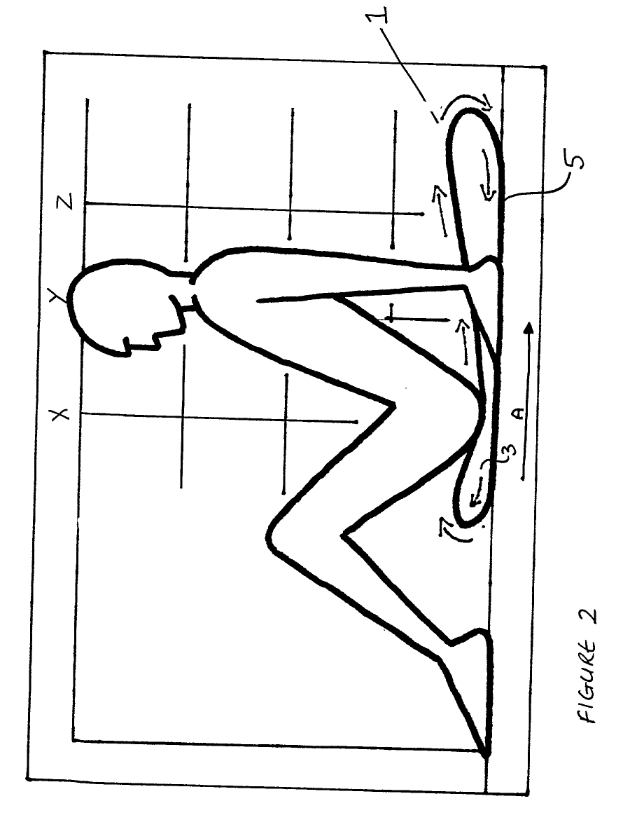

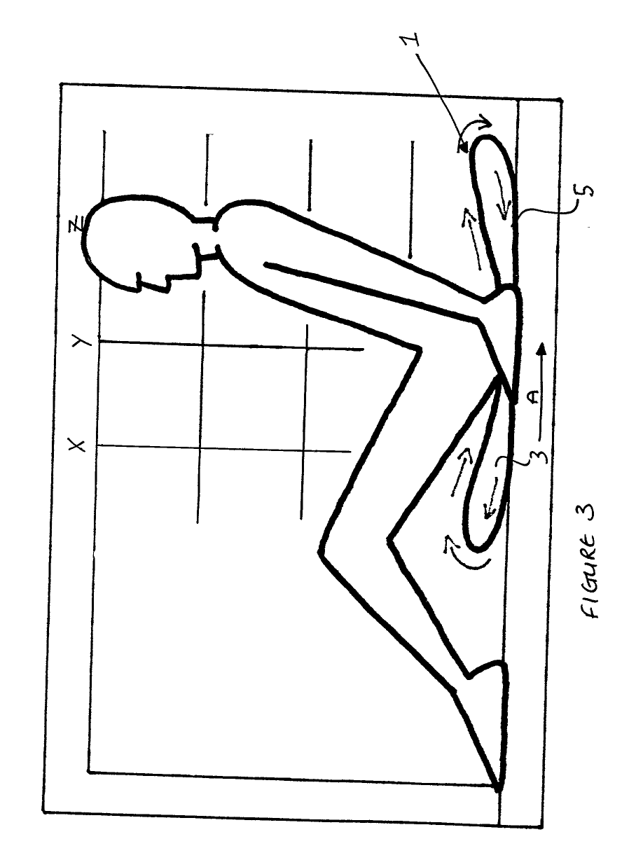

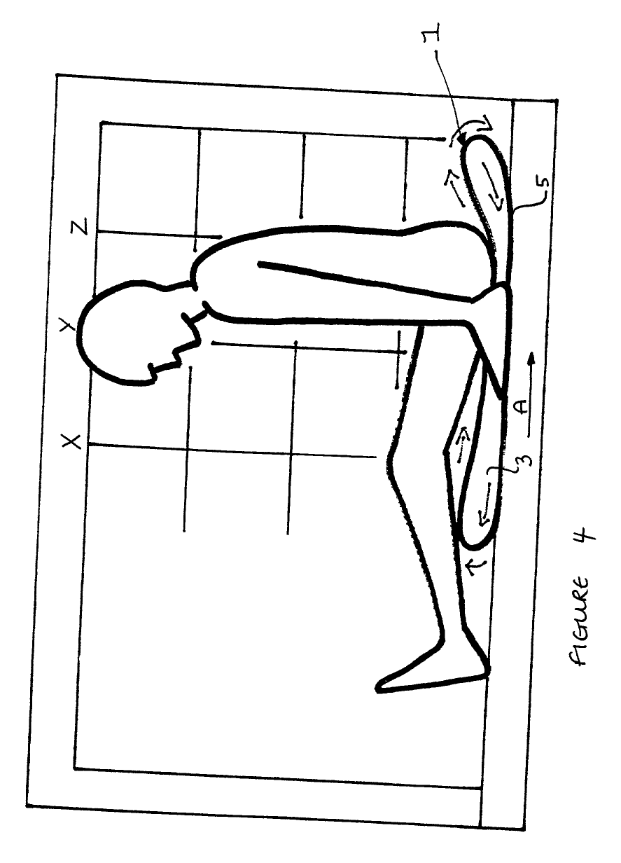

Referring to FIGS. 2, 3 and 4 where like numerals have been used to identify like parts identified in FIG. 1, there is provided a patient movement aid 1. In use, the patient is positioned on the outer surface 5 of the patient movement aid 1. The patient is then moved in the general direction of arrow A (either on their own or with the assistance of a helper). This movement results in opposed portions of the inner face 5 sliding relative to one another whilst the patient remains positioned on the patient movement aid 1, thereby moving the patient without the need to lift the patient off the patient movement aid 1. Further movement of the patient in the general direction of arrow A results in the patient being moved from position X to position Y and subsequently to position Z.

What is claimed is:

1. A patient movement aid for moving a patient from a first position on a support surface to a second position on the support surface, the movement aid comprising a flexible sheet including:
a unitary tubular member of blown plastics sheeting, said tubular member having longitudinally spaced first and second open ends, and a unitary seamless flexible web extending substantially continuously and uniformly from said first end to said second end,
said tubular member being arranged to lie flat under the weight of said patient such that opposed portions of an inner face of said web are in sliding contact with one another.

2. A patient movement aid according to claim 1, wherein the flexible web is seamless in at least one of a longitudinal direction and a transverse direction.

3. A patient movement aid according to claim 2, wherein the flexible web is seamless both in the longitudinal direction and in the transverse direction.

4. A patient movement aid according to claim 1, wherein the inner face of the flexible web has a low coefficient of friction to enable facile sliding movement of opposed portions of the inner face.

5. A patient movement aid according to claim 1, wherein the outer surface of the web has a higher coefficient of friction relative to the inner face so as to substantially inhibit sliding movement between the outer surface of the web and the support surface.

6. A patient movement aid according to claim 1, wherein the tubular member has an outer surface and an inner face, the outer surface having a higher frictional coefficient relative to the inner face.

7. A patient movement aid according to claim 6, wherein the inner face is provided with means for distinguishing the inner face from the outer surface.

8. A patient movement aid according to claim 1, which is substantially crease-resistant and is foldable for storage purposes.

9. A patient movement aid according to claim 1, wherein the sheet is substantially impermeable to water.

10. A method of moving a patient from a first position on a support surface to a second position on the support surface, the method comprising:
providing a patient movement aid according to claim 1;
placing the patient movement aid on the support surface such that the movement aid lies substantially flat on the support surface;
placing a patient on the patient movement aid; and
moving the patient over the support surface on the patient movement aid such that opposed portions of an inner face of the web slide relative to one another.
